(19) United States
(12) Patent Application Publication
(10) Pub. No.: US 2005/0182601 A1
(43) Pub. Date: Aug. 18, 2005

(54) Rack configuration determination support system

(75) Inventor: Masahira Deguchi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 10/879,755

(22) Filed: Jun. 30, 2004

(30) Foreign Application Priority Data
Feb. 13, 2004 (JP) 2004-037545

(51) Int. Cl. G05B 15/00; G06F 17/50; G06N 5/02; G06F 17/00; B67D 5/64

(52) U.S. Cl. 703/1; 706/47

(57) ABSTRACT

This system optimally arrays all components to be mounted, including supplementary components when mounting components selected by a user on a rack to build a target system. This system comprises a component DB composed of component definition data describing information about components that can be mounted on a rack and a rule DB composed of rule definition data describing a variety of rules led from a variety of prescribed viewpoints when arraying selected components on a rack. A user inputs the desired conditions of a target system, including the selection of components, and arrays each of the selected components according to a variety of rules in its selected order. The plurality of prescribed viewpoints includes the addition, quantity restriction and array of components, and the array designation of special components. Thus, an optimal array can be realized.

### BACKGROUND OF THE INVENTION

1. Field of the Invention

The present invention relates to a technique for supporting the selection of components and the determination of the array of each component on a rack when building a target system for arraying necessary or desired components on a rack.

2. Description of the Related Art

Such a system is already published by several companies, and a general user can also use the system. For example, as to the rack configuration of IBM, Rack Advisor of DELL or the like, the user can download its program through the Internet and execute the program on a computer. However, Rack Builder of HP can be used online as a rack building tool through the Internet.

Generally, when building a target system by mounting necessary or desired components, the following items (hereinafter called “checkpoints” for rackmount) must be taken into consideration.
Does a component to be mounted require another component?
Is the ratio in quantity between two kinds of interconnected components appropriate from the electrical and mechanical points of view?
Are the shape of a plug and that of a socket that is interconnected the same?
Is the length of the connection cable of two components sufficient to be located in their respective home positions and to be pulled out of a rack for their maintenance?
When all components cannot be accommodated on one rack, can another rack be added and the array of the added rack must be also determined.
What kind of a power supply is needed to feed all mounted components with sufficient power?
What kind of an UPS (uninterruptible power supply) is needed from the viewpoints of the total amount of power and power feeding hours of components to be fed?

As to any of the above-mentioned rack building tools, attention is paid to the product introduction of each company, and its main function is to estimate for a general consumer and to array components on a rack in descending order of weight. Therefore, a rack configuration taking into consideration the above-mentioned checkpoints cannot be expected from the conventional rack building tools.

In order to check the above-mentioned points, not only fairly high technical knowledge is needed, but also the specification of each component to be selected must be collected. Therefore, if a sales person or the like that is not familiar with the above-mentioned checkpoints builds a rack system using a conventional rack building tool, sometimes a component cannot be connected using a standard cable attached to the component as a standard accessory, due to insufficient length, and a new cable must be prepared again, which leads to late delivery.

Many of computer manufacturers/sellers have a family or series of products, for each usage or sales target. If its series differs, the checkpoints for rack mount also differ in the same rack mount system. Therefore, a rack system must be built for each series taking into consideration check points suitable for the series.

Therefore, it is an object of the present invention to provide a rack configuration determination support system capable of building a rack system taking into consideration check points for rack mount without collecting the knowledge of system configuration nor the specifications of a variety of components, a method thereof and a program thereof. The present invention also aims to provide a rack configuration determination support system which not only a general user can easily use like a conventional rack configuration tool, but a computer manufacturer/seller also can use it for his/her business purpose.

Specifically, it is an object of the present invention to provide a rack configuration determination support system capable of building a rack system taking into consideration check points suitable for each product series (type), a method thereof and a program thereof.

### SUMMARY OF THE INVENTION

According to one aspect of the present invention, a system for optimally arraying all components to be mounted, including supplementary components when mounting components selected by a user on a rack to build a target system can be provided. This system comprises a component database composed of component definition data describing information about components that can be mounted on the rack, a rule database composed of rule definition data describing a variety of rules led from a plurality of prescribed viewpoints when disposing the selected components on the rack, an input unit to which the user can input the desired conditions of a target system, including the selection of components, and an array unit arraying each of the selected components, according to a variety of rules in their selected order. Therefore, no special technical knowledge is needed and there is no need to collect information about components.

The component database comprises full information needed to optimally array components, and it is preferable for the rule database to cover all constraints and rules needed to optimally array components.

The plurality of prescribed viewpoints comprises the addition, quantity restriction and array of components, and the array designation of special components. Thus, an optimal array can be realized. The rule database comprises a rule definition file corresponding to each type of a target system. Therefore, a rack mount system suitable for each usage can be built. The component definition data can include the description of components essential to each component.

The input unit can set the connection/non-connection of a UPS in each component. Thus, a user's request can be flexibly responded to. If components include a component to which the connection of a UPS is set, the array unit comprises a unit selecting and adding an appropriate UPS.

If the capacity of a UPS is not sufficient, the array unit further comprises a unit adding a new UPS. If the selected components cannot be accommodated on one rack, the array unit comprises a unit adding a new rack.

According to another aspect of the present invention, a method for optimally arraying all components to be mounted, including supplementary components when mounting components selected by a user on a rack to build a target system can be provided. This method comprises a step of preparing a component database composed of component definition data describing information about components that can be mounted on a rack, a step of preparing a rule database composed of rule definition data describing a variety of rules that can be led from a plurality of prescribed viewpoints when arraying the selected components on a rack, an input step in which a user can input the desired conditions of a target system, including the selection of components, and an array step of arraying each of the selected components, according to the variety of rules in their selected order.

According to another aspect of the present invention, a computer-readable storage medium on which is recorded a data structure enabling a computer to optimally array all components to be mounted, including supplementary components when mounting components selected by a user to build a target system, can be provided. The data structure comprises a component database composed of component definition data describing information about components that can be mounted on the rack, a rule database composed of rule definition data describing a variety of rules led from a plurality of prescribed viewpoints when arraying the selected components on the rack, an instruction sequence enabling a computer to enable a user to input the desired conditions of the target system, including the selection of components, and an instruction sequence enabling a computer to array each of the selected components, according to a variety of rules in their selected order.

According to another aspect of the present invention, a program for enabling a computer that comprises both a component database composed of component definition data describing information about components that can be mounted on a rack in order to optimally array all components to be mounted, including supplementary components when mounting components selected by a user on the rack to build a target system, and a rule database composed of rule definition data describing a variety of rules led from a plurality of prescribed viewpoints when arraying the selected components on the rack so that the user can input the desired conditions of the target system, including the selection of components and also array each of the selected components, according to the variety of rules in their selected order, can be provided.

### BRIEF DESCRIPTION OF THE DRAWINGS

FIG. 1 is a block diagram showing the basic configuration of a rack configuration determination support system according to one preferred embodiment of the present invention;

FIG. 2 shows the basic configuration of a component DB 30 according to one preferred embodiment of the present invention;

FIG. 3 shows the basic configuration of a rule DB 70 according to one preferred embodiment of the present invention;

FIG. 4 shows the configuration of an XML document file designating a definition data file that constitutes both a component definition DB 30 and a rule definition DB 70;

FIG. 5 is a list indicating the meaning of each item used in product definition data;

FIG. 6 shows an example of the component definition data of a general CPU unit, whose model name is server6;

FIG. 7A shows exemplary CP definition data of a component CPa exclusively used for set products;

FIG. 7B shows exemplary CP definition data of a set product CPb composed of components CPa;

FIG. 8 shows an example of the definition of a component group defined by the present invention;

FIG. 9 shows the format of rule definition elements of the rule DB 70 according to the present invention;

FIG. 10 is a flowchart showing the process of a rack configuration determination support program according to one preferred embodiment of the present invention;

FIG. 11 is a flowchart showing the automatic generation process of the configuration/array of a rack system, conducted in step 200 of FIG. 10;

FIG. 12 shows the array process of selected components in the course of step 200 (steps 204 and 206);

FIG. 13 shows one screen displayed in step 104 of FIG. 10;

FIG. 14 shows one screen displayed in step 106 of FIG. 10;

FIG. 15 shows one screen displayed in step 112 of FIG. 10;

FIG. 16 shows one screen displayed in step 110 of FIG. 10;

FIG. 17 shows one screen displayed in step 114 of FIG. 10;

FIG. 18 shows one screen displayed in custom mode after step 200 shown in FIG. 10 is terminated (No. 1);

FIG. 19 shows one screen displayed in custom mode after step 200 shown in FIG. 10 is terminated (No. 2); and

FIG. 20 is a block diagram showing the basic configuration of a rack configuration determination support system with the second server 1a according to another preferred embodiment of the present invention.

### DESCRIPTION OF THE PREFERRED EMBODIMENTS

The details of the present invention are described below with reference to the preferred embodiments of the present invention and the drawings. When the same components are used in a plurality of drawings, the same reference numerals are attached to them.

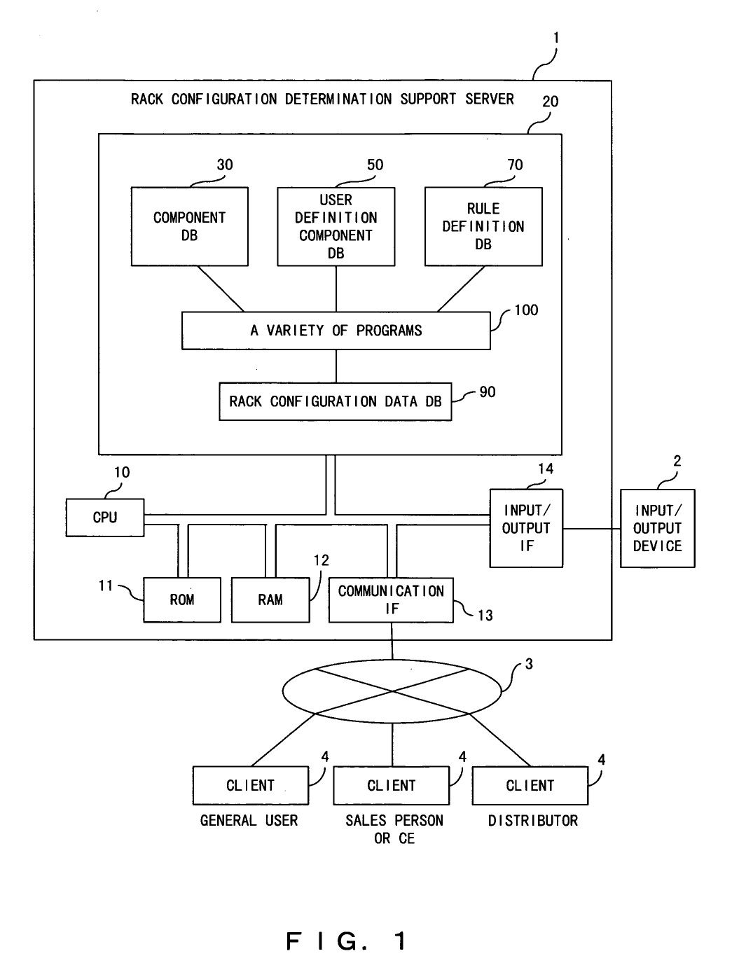

FIG. 1 is a block diagram showing the basic configuration of a rack configuration determination support system according to one preferred embodiment of the present invention. In FIG. 1, the rack configuration determination support system comprises a rack configuration determination support server 1, an input/output device 2 that is connected to this server and enables an operator to operate the server 1, and a client 4 that can access the server 1 through a network 3, such as the Internet or the like. The input/output device 2 generally comprises, for example, a keyboard, a pointing device, a display device and the like, which are not shown in FIG. 1. However, its components are not limited to them, and any component that can communicate with the server 1 through a human movement or senses can be used for it. The rack configuration determination support server 1 comprises, like a regular server, a CPU (central processing unit) 10, a ROM (read-only memory) 11, a RAM (random-access memory) 12, a communication interface communicating with the client 4 through the network 3, an input/output interface 14 interfacing the server 1 and input/output device 2, and a secondary storage device 20 storing programs and data that are needed to the functions of the rack configuration determination support server 1. The user of this system includes the sales persons and customer engineers (CE) of a computer manufacturer/seller possessing the rack configuration determination support server 1, the sales persons of a distributor and the like as well as general consumers.

The secondary storage device 20 is generally a hardware disk device. However, the device 20 is not limited to it, and any storage device that has both a satisfactory access time and a sufficient memory capacity with reasonable cost and high reliability can be used for it. The secondary storage device 20 stores the following data and programs.
(1) Component database (DB) 30: a set of information mainly about the specifications of components to be mounted on a rack (hereinafter called “CP”) that can be used for the rack configuration determination support server 1 system of the present invention
(2) User definition component DB 50: a set of component specifications defined by a user
(3) Rule DB 70: a set of the above-mentioned checkpoints composed of a variety of constraints and mount rules
(4) Rack configuration data DB 90: a set of the rack configuration data of a rack configuration system, determined using databases 30, 50 and 70 and using components desired by a user, and
(5) A variety of programs 100: a program for selecting the components of a rack mount system using both databases 30, 50 and 70, and components desired by a user, and for automatically arraying them on a rack and the like.

Many of these programs 100 are called and executed by a request from a client. As the mechanism of these programs, Java Servlet is currently preferable.

<The Features of the Rack Configuration Determination Support System>

The rack configuration determination support system has the following features.
(1) This is a self-conclusive rack configuration determination support system.

Since the component definition DB 30 and rule definition DB 70 include full information needed to determine a rack configuration, there is no need for a user to refer to another system, a literature, Web a page or the like, and no special technical knowledge is needed.
a) Notes unique to each product can be set.
b) Essential products can be registered.
c) A set product can be defined.
d) Components can be grouped.
(2) An appropriate rule definition file can be used for each system type. Different types of systems can also be mixed.
(3) Automatic rack selection

By designating a rack type, a rack can be automatically selected based on the quantity of components to be mounted.
(4) Automatic rack addition

If one designated rack cannot accommodate all designated components, a new rack is automatically added.
(5) Mount rules taking into consideration user friendliness and device characteristics are provided.
(6) Mount-prohibited position designation function

A user can prohibit a component from being arrayed in a specific position or range by designating the position or range of a rack.
(7) Automatic UPS selection function
a) Plug-socket shape-matching function
b) Power cable connection function
c) Cable length check function
(8) Display/print of the entire rack wiring
(9) Fixed attribute function

The application of a rule to a specific component can be excluded even during the application.
(10) Status display of rack configuration

The result of a rule check can be displayed by combining an icon and a simple table.

The checked results of regulations other than mount rules can be displayed.
(11) Registration function of user's unique component definition data
(12) Component list reading function
   (a model name can be directly input in direct mode)
(13) Existing attribute function: By setting an existing attribute in an existing rack configuration data, modifications after the setting can be output.
(14) Component save area function (component stock function):

Already mounted components can be temporarily removed and stored while editing a rack configuration in custom mode, and can be returned to the rack, as requested.
(15) A component data registration system is provided separately from the laid-open rack configuration determination support server 1.
(16) Both data registration and its correctness are checked, registered data is synchronized with mount rules, and the data is transferred to the server.
(17) All jobs related to a rack system ranging from order to installation/maintenance, such as presentation, the preparation of an estimate, the acceptance of an order, the preparation of a rack and components, the automatic assembly of a rack in cooperation with CAD and the like, can be supported.

Both the component DB 30 and rule definition DB 70 realizing the above-mentioned functions are described in detail below.

<Component DB 30 and Rule Definition DB 70>

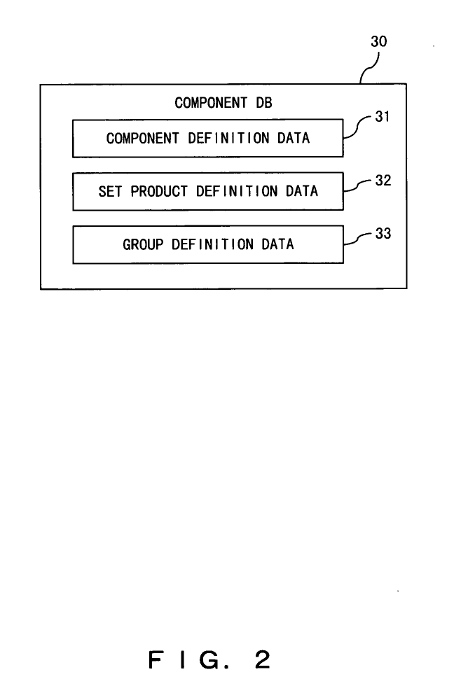

FIG. 2 shows the basic configuration of the component DB 30 according to one preferred embodiment of the present invention. In FIG. 2, the component DB 30 comprises component definition data 31 composed of information about regular discrete components, set product definition data 32, which is data for a set product, which is described later, regarded as one component by combining a plurality of components, and group definition data 33 defining a group of components which share a specific attribute, which is described later.

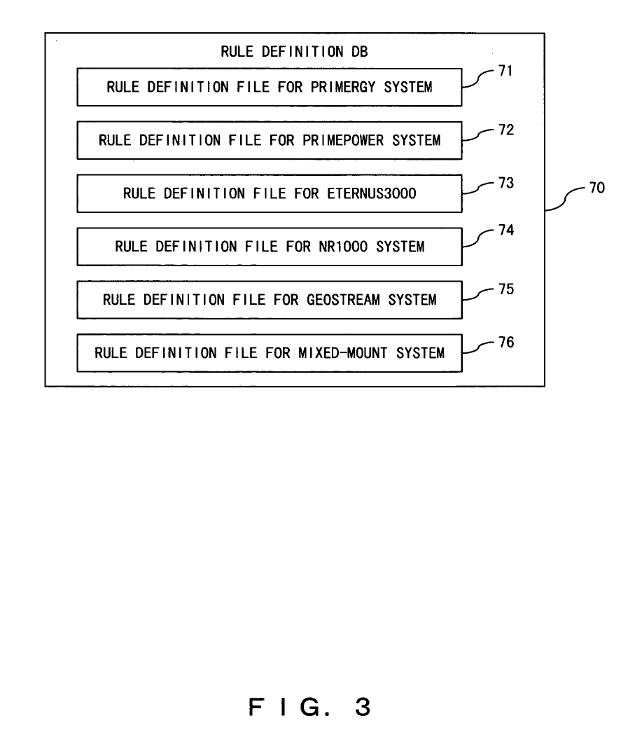

FIG. 3 shows the basic configuration of the rule DB 70 according to one preferred embodiment of the present invention. As shown in FIG. 3, according to the present invention, the rule definition DB 70 prepares an individual rule definition file for each system type shown in Table 1. Specifically, the DB 70 comprises rule definition files 71 through 76 corresponding to six types of a PRIMERGY system (PG), a PRIMEPOWER system (PW), an ETERNUS3000 system (GR), an NR1000 system (NR), a GeoStream system (GS) and a mixed-mount system (MX). Thus, an optimal rack system can be built based on constraints and rack mount rules that are suitable for each system type.

TABLE 1
Explanation of System Types

| System type | Symbol | Explanation |
|---|---|---|
| PRIMERGY system | PG | PC server and its |
| | | related products |
| PRIMEPOWER system | PW | UNIX server and its |
| | | related products |
| ETERNUS3000 system | GR | Disk array |
| NR1000 system | NR | Network disk array |
| GeoStream system | GS | IP switching node |
| Mixed-mount system | MX | Above systems are mounted |
| | | on a same rack |

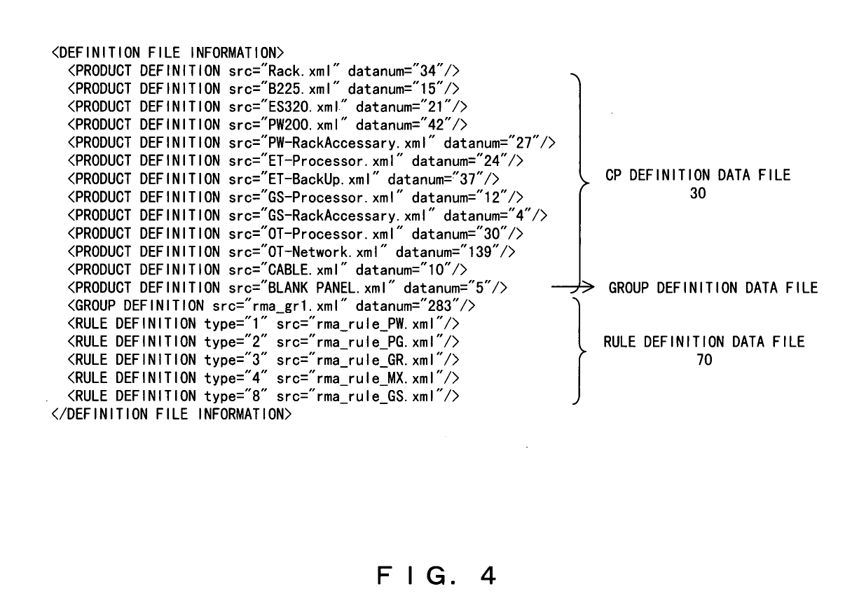

FIG. 4 shows the structure of an XML document file designating a definition data file that constitutes both the component definition DB 30 and rule definition DB 70. As seen from FIG. 4, each database used in the present invention is described in XML (extensible Markup Language). The data for each database can also be prepared using any other language or the existing database system. However, according to XML, no expensive database is needed, and a database that can be called a kind of flexible knowledge database incorporated with both necessary constraints and mount rules, can be built. In FIG. 4, an attribute “src” is a file name. An attribute “datanum” used in product definition and in group definition indicates the number of data for a component and the number of group data, respectively. An attribute “type” in rule definition is a system type.

In examples of the system definition file and a variety of database files shown in FIG. 4, a “product” means a “component” to be mounted on a rack. Therefore, although in the XML document of a database, a “product” is used to mean a component, in its description, “a variety of products to be mounted on a rack” are called “components”.

In the example shown in FIG. 4, the component (CP) database 30 also stores a rack definition file, Rack.xml, which stores 34 pieces of rack data. In this specific example, as to components, there are two types of definition data files for each system type. However, since the ETERNUS3000 system (GR) and NT1000 system (NR) both are disk array systems and can be regarded as the same type, a common definition data file is used. The definition data 32 of a set product does not comprise a special file, is handled as a regular component and is stored in each CP definition file. However, as the group of components, 283 groups are defined in a file rma_grl.xml. Rule definition files, ram_rule_PG.xml, ram_rule_PW.xml, ram_rule_GR.xml, ram_rule_GX.xml and ram_rule_MX.xml, respectively, are prepared for the PROMERGY system (PG), the PRIMEPOWER system (PW), the combination of the ETERNUS3000 system (GR) and NR1000 system (NR), the GeoStream system (GS) and the mixed-mount system (MX), respectively. When the rack configuration determination support system of the present invention is started, these files are automatically read and the process is prepared.

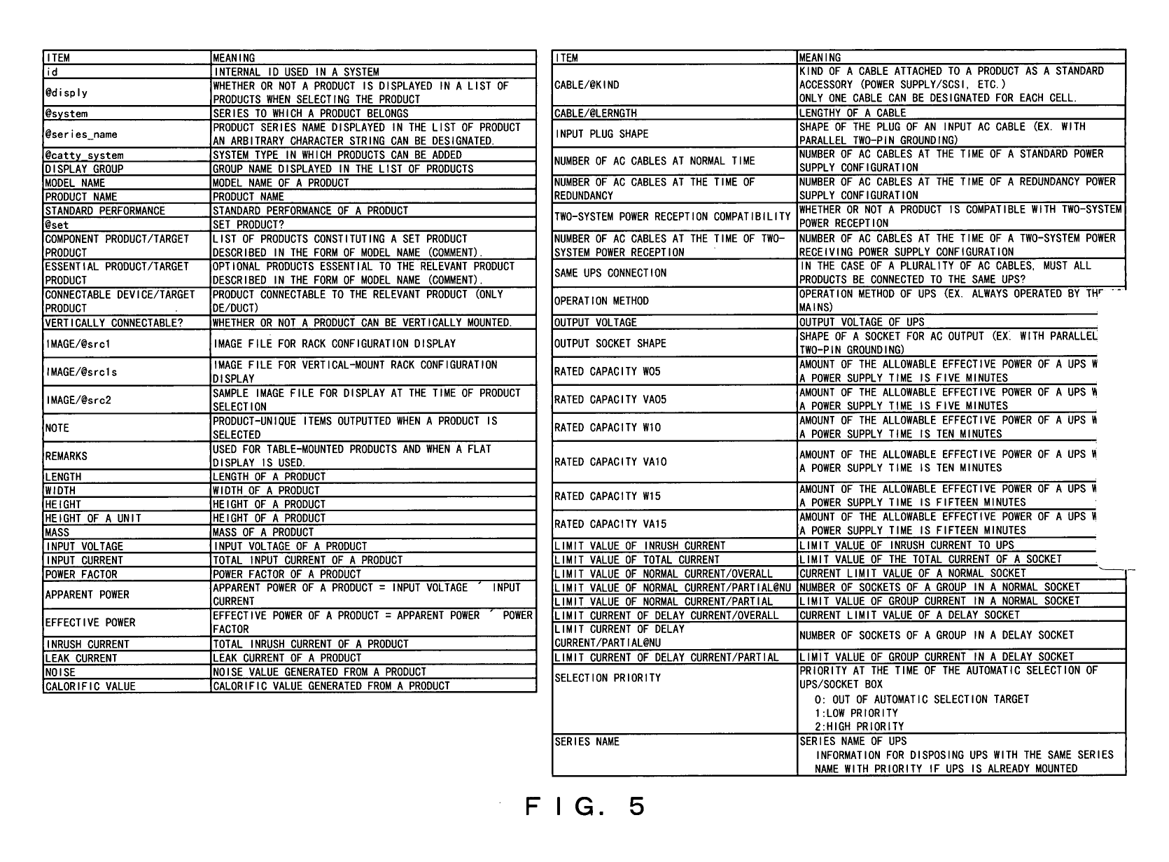

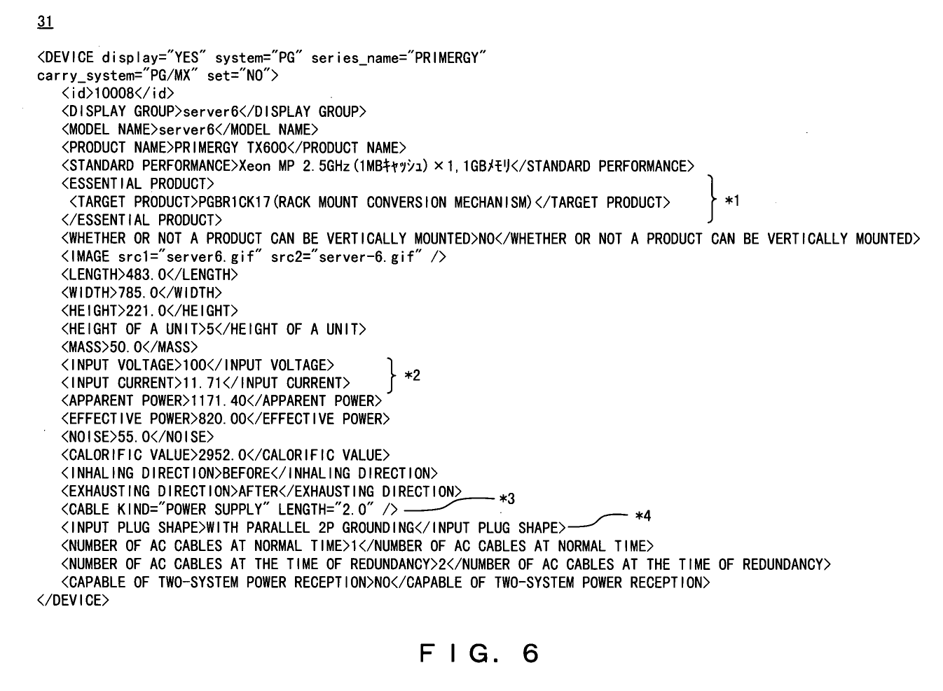

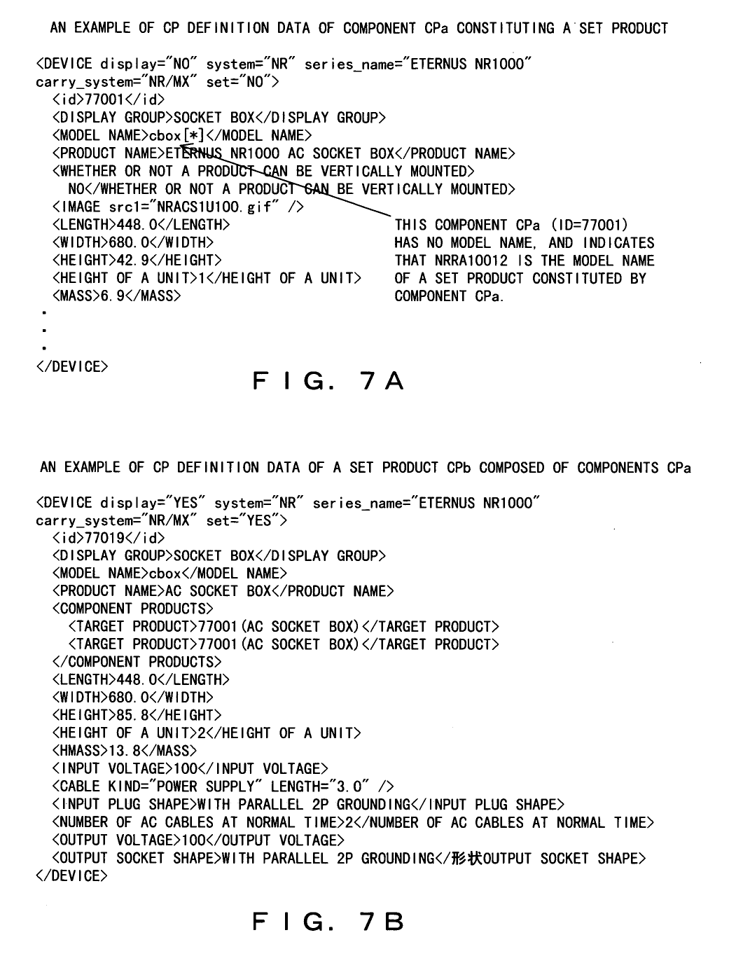

FIG. 5 is a list indicating the meaning of each item (or attribute) used in product definition data. The respective definition data of all components does not always include all the items, and that of some components does not include some items. FIG. 6 shows an example of the component definition data of a CPU unit, whose model name is server6. FIG. 7A shows exemplary CP definition data of a component CPa exclusively used for set products and FIG. 7B shows exemplary CP definition data of a set product CPb composed of components CPa. The CP definition data constituting the component definition DB 30 is described below with reference to FIGS. 5 through 7.

In each CP definition data, an item “id” is the identifier of a CP in a system, and “@display” indicates whether the system displays it in a list of selectable components when selecting components. For example, since the respective values of “@display” fields for a regular component server6 shown in FIG. 6 and an ETERNUS NR1000 AC socket box (a two-system set), being the set product shown in FIG. 7B, both are YES, they are displayed in a list of components when selecting components. However, since the value of @display” field for the component CPa shown in FIG. 7A is NO, it is not displayed in the list of components when selecting components (its reason is described later).

An item “@system” is a symbol attached to a series to which a product belongs, and item “@series_name” is a product series name displayed in a list of products, for which an arbitrary character string can be designated. An item “carry_system” indicates a system type in which the relevant component can be added or used, and any number of usable system type symbols can be listed up by inserting “/”. For example, since the server6 shown in FIG. 6 is carry_system=“PG/MX”, only the PRIMERGY system and mixed-mount system can be used. As shown in FIG. 5, the CP definition data of the component DB 30 can be incorporated with a variety of information needed to build a rack system.

Of these items, “input current”, “input voltage” (for example, *2 shown in FIG. 6) and a variety of output characteristic values are used to calculate the ratio in quantity between interconnected components.

An item “essential/target products (components)” designates an optional product essential to the relevant component. Thus, all other components necessary for the component can be procured. As described above, not only the CP definition data of the above-described rule definition DB 70 but also that of the component DB 30 includes much data influencing the building of a rack system.

“@set” indicates whether the relevant component is a set product, that is, is composed of a plurality of components. Neither server6 shown in FIG. 6 nor the AC socket box (id=77001) shown in FIG. 7A is a set product. Since as to the AC socket box (id=77019) shown in FIG. 7B, @set=YES, it is a set product. An item “component/target products” is an item that must be included if the relevant component is a set product, and constitutes a list of components for the set product. As seen from FIG. 7B, an AC socket box (id=77019) is composed of two AC socket boxes (id=77001).

There are two types of components that can constitute a set product. One type is handled in single as a regular component, has a model name and is displayed in a list of components when selecting components. The other is never used in single, does not have a unique model name, and is not displayed in the list of components when selecting components. The socket box (id=77001) shown in FIG. 7A is the latter. In FIG. 7A, although there is an item “model name”, its contents are NRRA10012[*]. [*] indicates that the model name described immediately before is not its model name and that of a set product that it constitutes, that is, a socket box 77019. A set product can be composed of only components exclusively used for a set product (having no model name) or can be composed of only components with regular model names. Alternatively, it can be composed of both types of components.

The items constituting the CP definition data shown in FIG. 5 further include an item “cable/@type” indicating the type of a cable usually attached to a component as a standard accessory, and an item “cable/@length” indicating the length of a cable. Therefore, it can be determined whether the attached cable can be used, by checking its relative position against the other component to be connected to it. Furthermore, there are an item “input plug shape” indicating the plug shape of an input AC cable, and an item “output socket shape” indicating the shape of its AC output socket. Therefore, it can be determined whether the attached cable can be used, by checking the respective shapes of a plug and a socket. If the cable cannot be used, a usable cable can be automatically selected.

The items constituting the CP definition data shown in FIG. 5 are not limited to those shown in FIG. 5. For example, if a new type of component appears and it is needed to describe the specification of the component, it can be added.

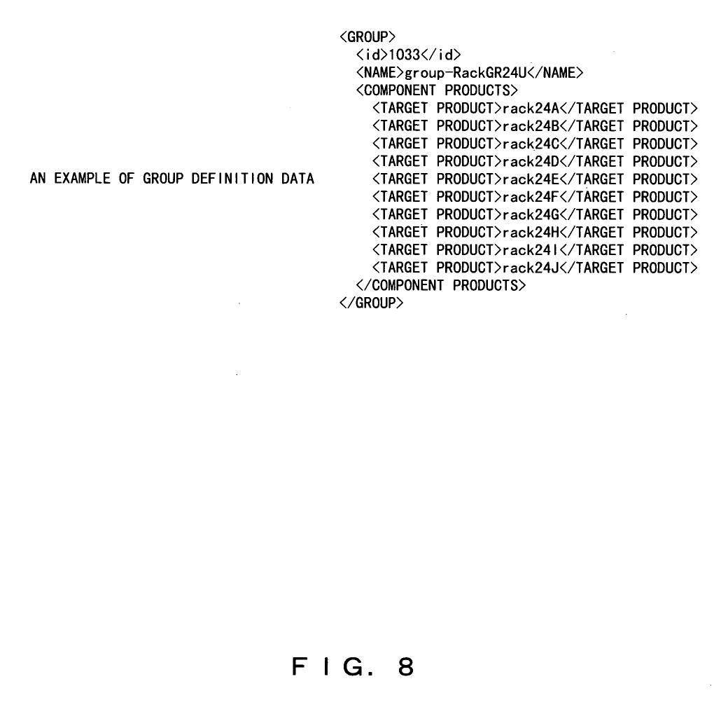

FIG. 8 shows an example of the definition of a component group defined by the present invention. In FIG. 8, this group definition data indicates grouping ten components enclosed by a target product tag using an identification “1033” and a name “group_RackGR24”. Each of the grouped ten components is equally handled using the same ID and name.

The component DB 30 that is prepared by the manufacturer of the rack configuration determination support server 1 or a company introducing the server 1 has been so far described. However, the user of the server 1 can register the CP definition data of a component that is not registered in the component DB 30, in the user definition component DB 50. The structure of the CP definition data of the user definition component DB 50 is the same as that of the definition data of the component DB 30.

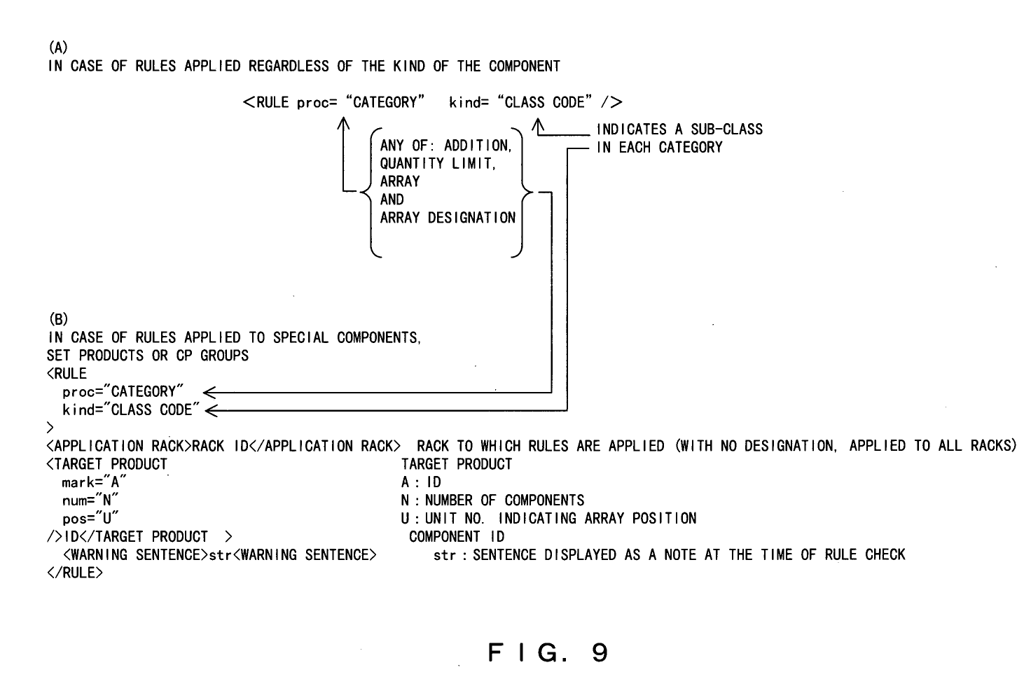

FIG. 9 shows the format of rule definition elements of the rule DB 70 according to the present invention. FIGS. 9A and 9B show a rule format applied regardless of the type of a component, and that applied to a special component, a set product or a CP group, respectively. Examples of the descriptions in XML for a variety of mount rules used in the rack configuration determination support server 1 of the present invention are shown in Table 2. Firstly, in FIG. 9, a “category”, which is the value of an attribute “proc”, indicates the rough classification of rules. “class No.”, which is the value of an attribute “kind”, indicates the detailed classification of “category”, and is indicated by three digits in this preferred embodiment. This preferred embodiment has four categories of “addition”, “quantity restriction”, “array” and “array designation”.

In the rules shown in FIG. 9A, a rule whose contents are indicated by the class No. of a designated category is applied to all of a component, a set product and a CP group. The rule applied regardless of a component type includes, for example, the class Nos. 101, 201, 202, 301 and the like of the category “addition”.

As shown in FIG. 9B, the other rule is applied to only a target component designated by ID. In FIG. 9B, the value “A” of “mark” is an identification symbol for distinguishing a specific component from the other components, and the value “N” of “num” is the number of components. The value “U” of “pos” is a unit No. indicating an array position. A specific position in the rack of the present invention is indicated by a unit number that is sequentially applied to each unit height from the bottom. “str” is a sentence indicating a note at the time of rule check.

TABLE 2
List of Rules

| proc | kind | Description |
|---|---|---|
| Addition | 101 | Addition of a necessary component |
| | | <target product>id</target product> |
| | | If there is no “id” on a rack, “id” |
| | | is added on the rack. |
| | 102 | Addition of a necessary component |
| | | <target product mark=”A”>id1 |
| | | </target product> |
| | | <target product>id2</target product> |
| | | <target product>id3</target product> |
| | | If there is neither id1, id2 nor id3, a |
| | | target product to which mark=”A” |
| | | is attached is added on the rack. |
| | 103 | If there is a product without a mark on a rack, |
| | | a product with a mark is added. |
| | | <target product mark=”A”>id1</target |
| | | product> |
| | | <target product>id2</target product> |
| | | <target product>id3</target product> |
| | 201 | <Essential component> designated by a |
| | | product is checked, and is added if it does |
| | | not exist. |
| | 202 | <Essential component> designated by a |
| | | product is checked, and is unconditionally |
| | | added. |
| | 301 | A necessary UPS is selected, and is added or |
| | | updated. |
| Quantity | 101 | The number of “id” is limited up to |
| restriction | | “n” on one rack. |
| | | <target product num=”n”> |
| | | id</target product> |
| | 201 | If a plurality of racks is used, the number |
| | | of “id” is limited up to “n” in |
| | | one configuration. |
| | | <target product num=”n”>id |
| | | </target product> |
| | 301 | Quantity restriction by pattern |
| | | If there is a product without a mark on a rack, |
| | | there must be a designated number of products |
| | | with a mark on a rack. |
| | | <target product num=”n1”>id1</target |
| | | product> |
| | | <target product num=”n2” |
| | | mark=”A”>id2</target product> |
| | | If there are n1 “id1” on a rack, there |
| | | must be n2 “id2” |
| | | (the number of “id2” must be neither |
| | | more than n2 nor less than n2). |
| | 302 | Quantity restriction by pattern (only for |
| | | rule check) |
| | | The same rules as quantity restriction 301 |
| | | However, even if a pattern cannot be applied, |
| | | components can be arrayed |
| | | (this is displayed only in the notes for rule |
| | | check and the like). |
| Array | 101 | <target product>id1</target product> |
| | | <target product>id2</target product> |
| | | <target product>id3</target product> |
| | | <target product mark=”A”>id4 |
| | | </target product> |
| | | Components are sequentially arrayed from the |
| | | bottom in order of id4, id3, id2 and id1 |
| | | (“id” can be designated to category/group). |
| | | If there are different types of components |
| | | in the same category/group, a component with |
| | | a heavier weight is arrayed on the bottom. |
| | | For id4 with a mark, see example 5 of array |
| | | designation 101. |
| Array | 101 | Array to a designated position of a special |
| designation | | pattern |
| | | If there are products satisfying the |
| | | following conditions on a rack, a component |
| | | is arrayed to a designated position. |
| | | Example 1) |
| | | <target num=”1”>id</target product> |
| | | <target num=”2”>id</target product> |
| | | “num” of products indicated by “id” |
| | | are arrayed in written order of target product |
| | | tags. |
| | | If 0 is assigned to “id”, a vacant U is |
| | | designated. |
| | | If 1 is assigned to “id”, a vacant U is |
| | | designated |
| | | (However, if a component is arrayed on the |
| | | top, a vacant area is not secured). |
| | | If 2 is assigned to “id”, a vacant U is |
| | | designated |
| | | (However, if a component is arrayed on the |
| | | bottom, a vacant area is not secured). |
| | | Example 2) |
| | | <target product num=”2”>id |
| | | </target product> |
| | | <target product num=”1” |
| | | pos=”15, 25”>id</target product> |
| | | “num” of products indicated by “id” |
| | | are arrayed in written order of target product |
| | | tags. |
| | | “15, 25” designated in “pos” |
| | | indicates that the first and second candidates |
| | | of an array position are 15U and 25U, |
| | | respectively. |
| | | Example 3) |
| | | <target product num=”2”>id |
| | | </target product> |
| | | <target product num=”1” |
| | | pos=”15-25”>id</target product> |
| | | “num” of products indicated by “id” |
| | | are arrayed in written order of target product |
| | | tags. |
| | | “15-25” designated in “pos” |
| | | indicates that components are mounted between |
| | | 15U and 25U (array priority is given to 15U). |
| | | Example 4) |
| | | <target product num=”1” |
| | | pos=”u22”>id</target product> |
| | | If there are “num” of “id”, |
| | | components are arrayed in positions shown |
| | | in “pos”. |
| | | If “num” is 1, the rule is |
| | | unconditionally applied (u22 indicates 22U |
| | | or higher). |
| | | Example 5) |
| | | <target product num=”1” |
| | | pos=”r22”>id</target product> |
| | | If “pos” is designated with ‘r’ |
| | | attached, a component is mounted regardless |
| | | of the priority set in array 101. |
| | | However, the priority cannot be higher than |
| | | that of a target product with a mark in array |
| | | 101. |
| | | Example 6) |
| | | <target product num=”1” |
| | | pos=”o22”>id</target product> |
| | | ‘o22’ indicates 22U or lower. |
| | | Example 7) |
| | | <target product num=”1” |
| | | pos=”w22”>id,/target product> |
| | | If “num” of “id” are already |
| | | mounted higher than a designated U, the other |
| | | “id” must be mounted higher than the |
| | | designated “pos”. Therefore, “num” |
| | | must be 1. |
| | 201 | A remaining special pattern is set higher. |
| | | A specific device of the devices not |
| | | extracted as a special pattern is extracted |
| | | at the time of the array of a special |
| | | pattern. |
| | | If a component exists in the pattern, the |
| | | device is added to the special pattern. |
| | | <target product>id</target product> |
| | | Prior to the description of array |
| | | designation 201, the special pattern of |
| | | “id” must be described. |
| | 301 | The bottom of a rack is cleared. |
| | | <target product>id</target product> |
| | | If a device designated by “id” is |
| | | to be arrayed at the bottom, the bottom |
| | | portion of the rack must be reserved. |
| | | If id = 0, the bottom of a rack must |
| | | be always cleared. |

<Operation by the Rack Configuration Determination Support Program of the Present Invention>

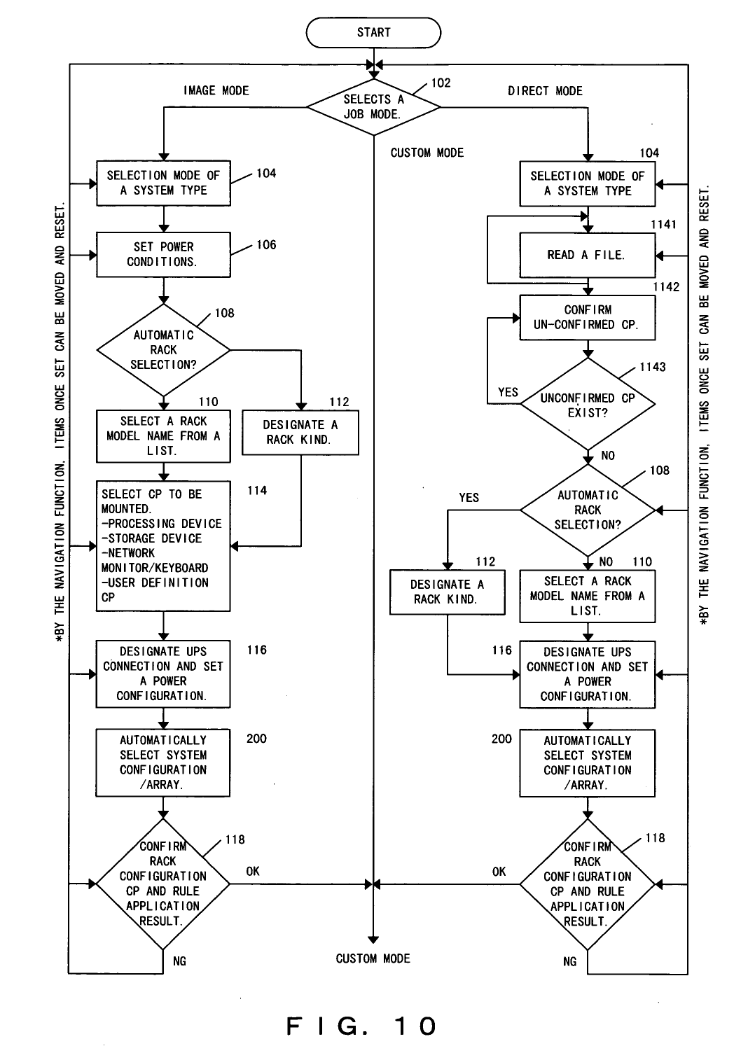

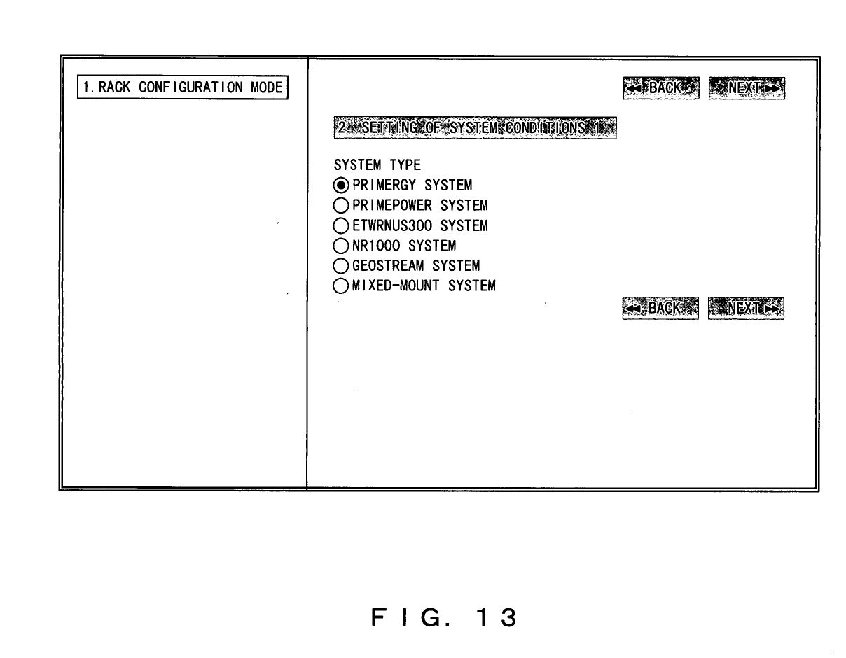

Apart of the contents of an actual rule definition file 71 prepared for a PRIMERGY system in the rule definition DB 70 of this preferred embodiment is attached as <Appendix>. The operation of a CPU 10 under the control of the rack configuration determination support program of the present invention is described below with reference to both this rule definition file 71 and the drawings. FIG. 10 is a flowchart showing the process of a rack configuration determination support program according to one preferred embodiment of the present invention. FIGS. 13 through 17 shows examples of screens displayed in the course of the process shown in FIG. 10. In FIG. 10, if a rack configuration determination support program is started, in step 102, one of the three modes of this system, that is, an easy mode, a custom mode and a direct mode, is selected. In easy mode, after a user inputs all desired components according to the guidance of a program, the program automatically determines an optimal rack configuration and displays its result on a custom mode screen. In custom mode, every time a user selects a component, the program determines a configuration while displaying its array. In this case, an arrayed component can also be moved or deleted. In direct mode, products to be used, such as CSV files and the like, can be collectively input, an optimal configuration can be automatically determined, and its result can be displayed on a custom mode screen.

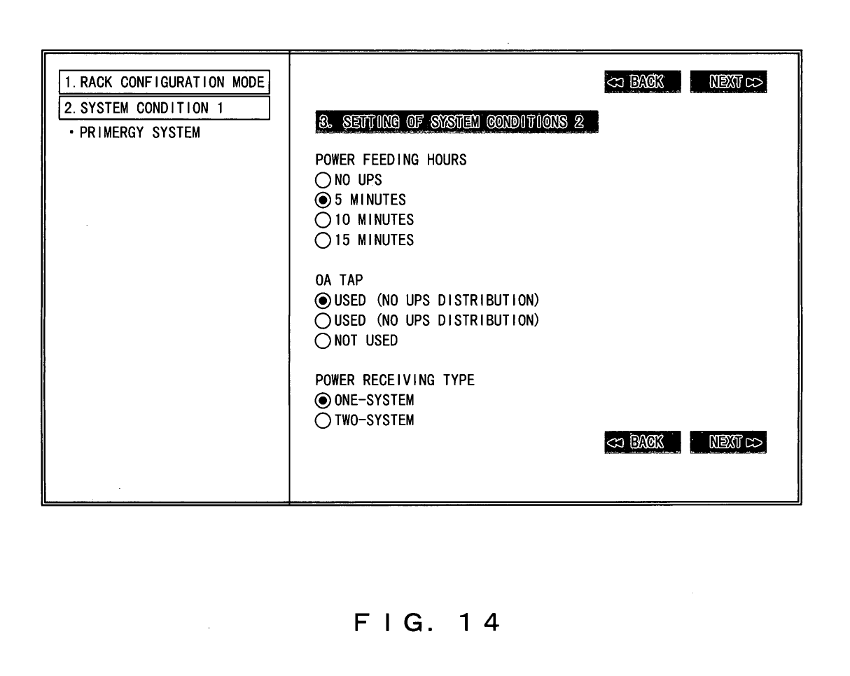

If the easy mode is selected, in step 104, a system type is selected in the screen shown in FIG. 13. In this preferred embodiment, it is selected from the earlier-described six system types. Then, in step 106, system conditions for a power supply are set. Specifically, in the screen shown in FIG. 14, it is determined whether to use a UPS, what are its power feeding hours if it is used, whether an OA tap is used, whether the UPS is distributed if it is used, which its power feeding type is, one-system or two-system, and the like.

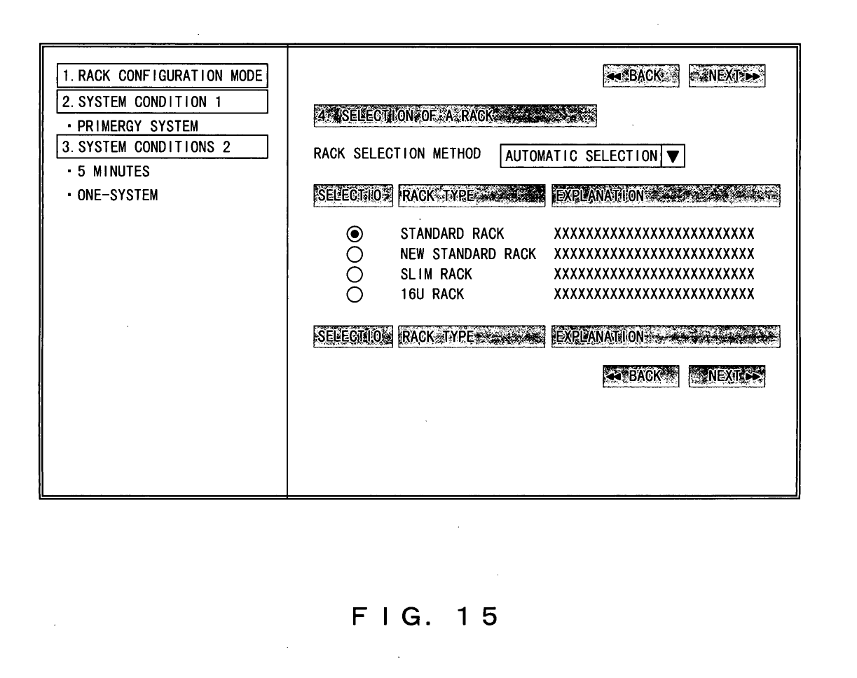

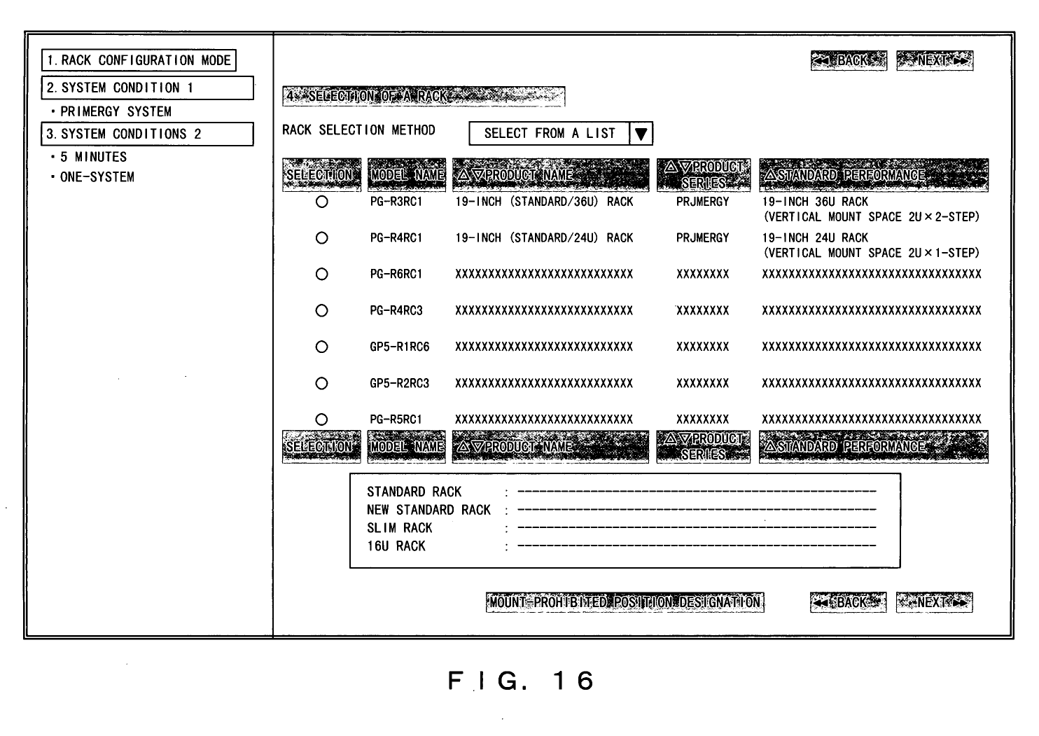

Then, in step 108, it is determined whether a rack is automatically selected. If it is not automatically selected, in step 110, it is selected from the list of racks displayed on the screen shown in FIG. 16. If it is automatically selected in step 108, in step 112, the type or kind of a rack is selected on the screen shown in FIG. 15.

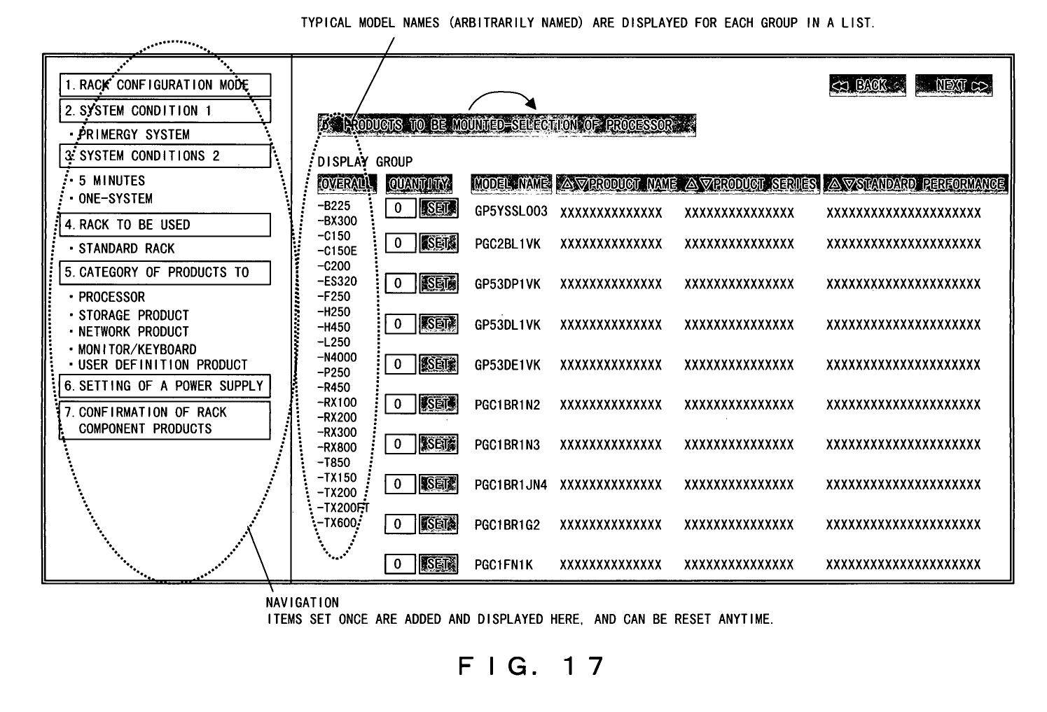

After step 110 or 112, in step 114, a processor, a storage device, a network-related component, a monitor, a keyboard and the like are sequentially selected from the components displayed on the screen shown in FIG. 17. In this case, the system of the present invention displays only components corresponding to the relevant system type so as to avoid improper selection (, such as the selection of a component that cannot be handled in a selected system type) when selecting components to be mounted. When displaying a list of components, the component DB 30 is referenced. However, by checking the item @carry_system of the CP definition data, it can be determined whether the relevant component should be displayed, based on the selected system type. If the server is not selected, a sentence “A product requiring a monitor is not selected” is displayed in the monitor selection screen, and no list of monitors is displayed. When selecting components to be mounted, the definition data of a user definition component can be registered in the user definition component DB 50 as requested.

After selecting necessary components thus, in step 116, both UPS connection designation and the setting of a power configuration are conducted. In step 200, the configuration/array of a rack system is automatically generated by setting the above-described contents as described in detail later. In step 118, an automatically generated result is confirmed. At this moment, a component can be added, moved or deleted by the navigation function of the system, if necessary.

If in the first step 102, the direct mode is selected, the process is as follows. Components are not selected one by one in step 114, not as in the easy mode. Instead, in step 1141, the model names of components to be used are read from a CSV file and in step 1142, unconfirmed components are repeatedly confirmed until there is no unconfirmed component (step 1143). Since the process other than it of the direct mode is the same as that of the easy mode, its description is omitted.

After this, the following setting is assumed in steps 104 through 116 in order to describe the operation of step 200 in detail.
System type: PRIMERGY system
Power feeding condition:
   UPS used for five minutes/OA tap is used (no UPS distribution)/one system
Rack type: 19-inch (standard/24 U) rack [PG-R4RC1]
Selected components:
   server6×1,server3×1, server1×2(server), Cabinet [cabi001]×1 (backup cabinet) Flat display [flato1]
      It is assumed that these components are selected from left to right and from top to button.
UPS connection: UPS connection for other than a flat display and a cabinet

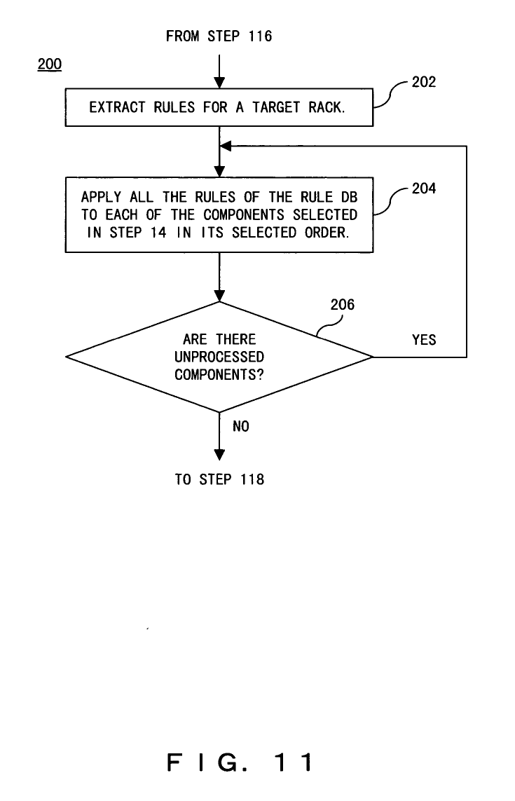

If after step 116, a button “completed” is pushed on the last screen of the easy mode, in step 200, the configuration/array of a rack system is automatically generated. FIG. 11 is a flowchart showing the automatic generation process of the configuration/array of this rack system. In FIG. 11, firstly in step 202, the rules of a target rack are extracted. In this example, rules for the model name PG-R4RC1 of a 19-inch (standard/24 U) rack are extracted. In step 204, all rules defined in the rule DB of each selected product are checked in their selected order, and necessary rules are applied. In determination step 206, it is determined whether there are unprocessed components in the selected components. Steps 204 and 206 are repeated until there is no unprocessed component. In this preferred embodiment, in step 204, the process is performed based on the attached rule definition file of the PRIMERGY system. The attached rules are applied to each of the selected components in its selected order as follows.

Since the first selected component is server6, firstly, the process of server6 is performed.

CPI: the Process of Server6

A rule R1 (that is, the class No. 202 of a category “addition” of Table 2)(hereinafter simply called “addition 202”) is applied, and an additional process is performed.

Since as to the server6, essentials (marked with *1 shown in FIG. 6) are defined, defined PGBR1CK17 (rack mount conversion mechanism) is automatically added.

Then, the addition/update of an UPS is performed by a rule R2. Specifically, since UPS connection is designated for server6, as assumed as the above-mentioned setting condition, 3000 VA, which is a UPS with the smallest capacity of the UPSs that meet the capacity requirements, such as power consumption, input power and the like, of server6 is automatically added. As described above, if UPS addition/update is performed, a process target is shifted to the added UPS. Therefore, the addition process of 3000VAUPS is temporarily performed.

CP2: 3000VAUPS
By rule R1, an addition process is performed. However, since there is neither set products nor essentials, nothing is performed.
By rule 2 (addition 301 shown in Table 2), UPS addition/update is performed. However, a UPS is not connected to another UPS, nothing is performed.
Quantity check: Since there are rules R5 through R8 for 3000VAUPS, the rules are checked one by one. Each of rules R5 through R8 has the following means.
   R5: At maximum three 3000VAUPS on one rack.
   R6: If there are three 3000VAUPS on one rack, no 1400/1500VAUPS cannot be mounted.
   R7: If there are two 3000VAUPS on one rack, only one 1400/1500VAUPS can be mounted.
   R8: If there is one 3000VAUPS on one rack, at maximum five 1400/1500VAUPS cannot be mounted.
In this case, since there is only one 3000VAUPS, no rule applies.
By rule 3, an array process is performed. Since 3000VAUPS belongs to the last group of an array rule as a UPS, it is mounted on the bottom of the rack.
Re-array by a special pattern: The height of a UPS is restricted to 24 or less by rule 10. However, it is mounted at the bottom of the rack, there is no problem.

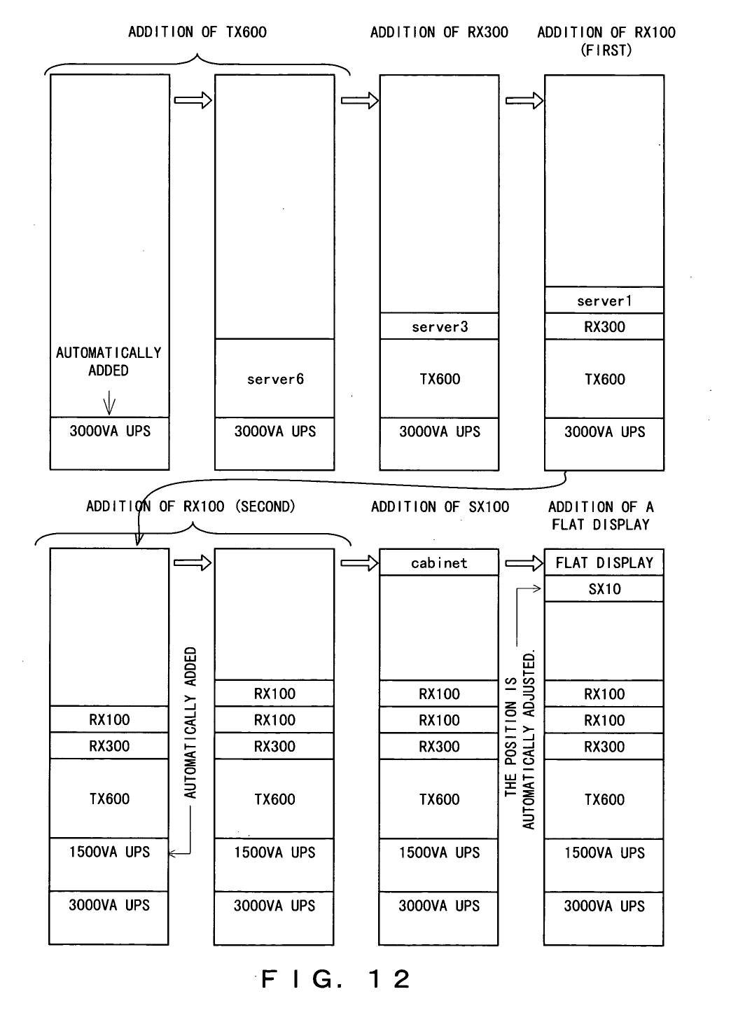

FIG. 12 shows how selected components are arrayed in the course of the process of in step 200 (actually steps 204 and 206). By the process of 3000VAUPS, the UPS is arrayed as shown in the leftmost rack in the upper section.

Since the UPS is arrayed thus, the process of server6 is continued.

Continued Process of Server6

Quantity check: Since there is no rule for server6, nothing is performed.

Basic array: An array process is performed according to rule 3. Thus, server6 is mounted on 3000VAUPS.

Re-array by a special pattern: Rule 4 (array designation 301 in Table 2) is described for server6. It is defined that if a defined product is mounted at the bottom of the rack, 1 U at the bottom of the rack is left unoccupied. Since server6 is not mounted at the bottom of the rack, this rule does not apply.

Thus, server6 is arrayed as shown on the second rack from the left in the upper section of FIG. 12.

CP3: the Process of Server3

An addition process (rule R1) is performed. However, no essentials are defined, nothing is performed.

UPS addition/update (rule R2) is performed. Since UPS connection is designated for server3, it is calculated that 3000VAUPS satisfies the required capacity in the course of execution of the UPS addition/update rule. Therefore, there is no addition/update of the UPS (actually, a UPS with the smallest capacity of the UPSs that satisfy the capacity requirements, such as the total power consumption, input power and the like, of both server6 and server3).

Quantity check: There are no rules for server3.

Basic array: An array process is performed according to rule R3. Since server3 is described prior to server6, server3 is mounted on server6.

Re-array by a special pattern: Rule R4 is described for server3. However, since server3 is not mounted at the bottom of the rack, nothing is performed.

Thus, server3 is arrayed as shown on the second rack from the right in the upper section of FIG. 12.

CP4: the Process of Server1 (The First)

Since no essentials are designated, no addition process (rule R1) is performed.

UPS addition/update (rule R2): UPS connection is designated for server1. If IPS addition/update rule is applied, it is calculated that 3000VAUPS meets the capacity requirements. Therefore, there is no addition/update of a UPS (actually, a UPS with the smallest capacity of the UPSs that satisfy the capacity requirements, such as the total power consumption, input power and the like, of server6, server3 and server1).

Quantity check: There are no rules for server1.

Basic array: By an array process according to rule R3, server1 is mounted on server3.

Re-array by a special pattern: There are no rules for server1.

Thus, server1 is arrayed as shown on the rightmost rack in the upper section of FIG. 12.

CP5: the Process of Server1 (The Second)

Addition process (rule R1): No essentials are designated.

UPS addition/update (rule R2): UPS connection is designated for server1. If UPS addition/update rule is applied, it is found that 3000VAUPS does not meet the capacity requirements. Therefore, one UPS is added (actually, a combination of UPSs with the smallest capacity of the combinations of UPSs that satisfy the capacity requirements, such as the total power consumption, input power and the like, of server6, server3, server1 and server1).

Since there is UPS addition/update, a process target is shifted to the addition of 1500VAUPS.

CP6: the Process of 1500VAUPS
Addition process (rule R1): Since there is no designation, nothing is performed.
UPS addition/update (rule R2): Since a UPS is not connected to another UPS, nothing is performed.
Quantity check: There are rules R5, R9 and R6 through R8, each of their meanings is as follows.
R5: At maximum three 3000VAUPSs on one rack
   [symbol] Since there is only one 3000VAUPS, there is no problem.
R9: At maximum five 1400/1500VAUPSs on one rack.
   [symbol] Since there is only one 1400/1500VAUPS, there is no problem.
R6: If there are three 3000VAUPS on one rack, no 1400/1500VAUPS can be mounted.
   [symbol] Since there is only one 3000VAUPS, there is no problem.
R7: If there are two 3000VAUPS on one rack, only one 1400/1500VAUPS can be mounted.
   [symbol] Since there is only one 3000VAUPS, there is no problem.
R8: If there is one 3000VAUPS, at maximum five 1400/1500VAUPS can be mounted.
   [symbol] Although there is one 3000VAUPS, there is no 1500VAUPS. Therefore, there is no problem.
Basic array (rule R3):
   Since 1500VAUPS is lighter than 3000VAUPS in the UPS group, it is mounted on 3000VAUPS.
Re-array by a special pattern:
   Although by rule R10, the height of an UPS is restricted 24 or less, there is no problem.
Thus, server1 (the second) is arrayed as shown on the leftmost rack in the lower section.
   The Continued Process of Server1
Quantity check: there are no rules for server1.
Basic array: By rule R3, server1 (the second) is mounted on server3. Since one server1 (the first) is mounted on server3, actually server1 (the second) is mounted on server1 (the first).
Re-array by a special pattern: There are no rules for server1.

Thus, the server1 (the second) is finally arrayed as shown on the second rack from the left in the lower section.

CP7: the Process of Cabinet

Addition process (rule R1): Since no essential products are designated, nothing is performed.

UPS addition/update (rule R2): Since no UPS connection is designated for cabinet, nothing is performed.

Quantity check: There are no rules for cabinet.

Basic array: By rule R3, a cabinet is mounted at the bottom.

Re-array by a special pattern: There are rules R11 and R12 for cabinet.

Rule R11 is as follows.
<target product num=“0” pos=“24”> sysgrp-8chSwitch</target product>
<target product num=“1” pos=“24”>sysgrp-PGFlaatDisplay</target product>
<target product num=“0”>cabi001</target product>

Although this is a rule for a flat display, this rule can also be applied to an 8-ch switch (in this example, with no selection) and the mount position of a cabinet. The flat display is mounted in the position of 24 U. However, if there is an 8-ch switch (sysgrp-8chSwitch), the 8-ch switch is mounted on 24 U, and the flat display is mounted under it. If there is further a cabinet, the cabinet is mounted under it (under the flat display). In the case of this combination, there are no restrictions to the respective quantity of 8-ch switches and cabinets (num=0), and as a result, the position of the cabinet is not influenced by rule R11.

Rule 12 is as follows.
<target product num=“1” pos=“24”>cabi001</target product>
<target product num=“0”>cabi001</target product>

The cabinet is mounted on 24 U, and another cabinet is also mounted under it. Since there are no quantity restrictions at the bottom, a plurality of S×10 is sequentially mounted on 24 U downward. In this example, since there is no flat display, the cabinet is mounted in the position of 24 U.

Thus, the cabinet is arrayed as shown on the second rack from the right of the lower section.

CP8: the Process of a Flat Display

Addition process (rule R1): Since there are no essential products, nothing is performed.

UPS addition/update (rule R2): Since no UPS connection is designated for a flat display, nothing is performed.

Quantity check (rule R13): The quantity of flat display per rack is restricted to one. However, there is only one flat display, there is no problem.

Basic array (rule R3): Since a flat display belongs to the last line “sysgry_Monitor” of the array rule, it is mounted at the bottom.

Re-array by a special pattern: There is rule R1 for a flat display and there are no 8-ch switches. Therefore, the flat display is mounted on 24 U. Furthermore, since there is a rule that a cabinet should be mounted under the flat display, the already mounted cabinet is moved under the flat display, according to this rule. Thus, a flat display is arrayed as shown on the rightmost rack of the lower section in FIG. 12.

Since as described above, all the selected components are processed, the process proceeds to the earlier-described step 118.

Although not described above, there can be a case where one rack cannot accommodate all selected components. In such a case, the above-described rack configuration determination program automatically adds a rack, and applies the process in step 200 to both the added rack and unaccomodated components.

If components are connected by a cable, the matching of the respective shapes of a plug and a socket is checked. If a cable attached to a specific component as a standard accessory does not fit, an appropriate cable is added. Furthermore, the necessary length of a cable is calculated also taking into consideration both the distance between components to be interconnected and redundancy for pulling the interconnected components out of the rack at the time of maintenance. If the length of a cable attached to each component as a standard accessory is not sufficient, a cable with an appropriate length is added.

As described above, according to the rack configuration determination program of the present invention, an optimal rack configuration can be realized according to the contents of the respective definition data of the component DB 30 and rule definition DB 70.

<Custom Mode>

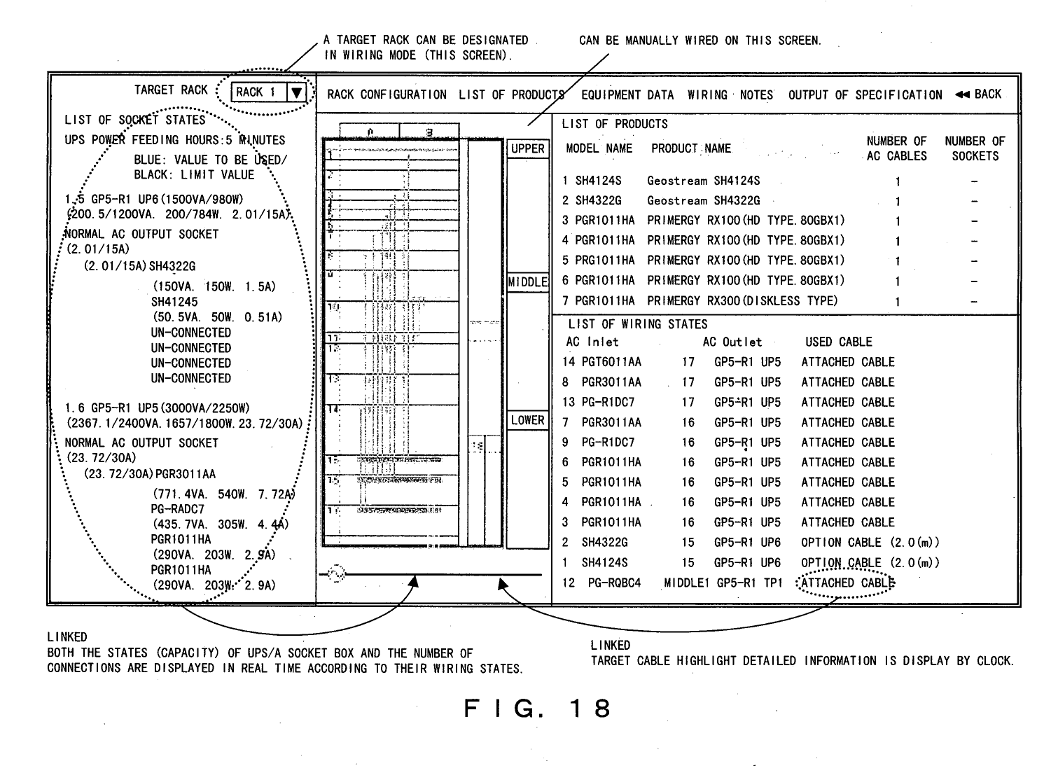

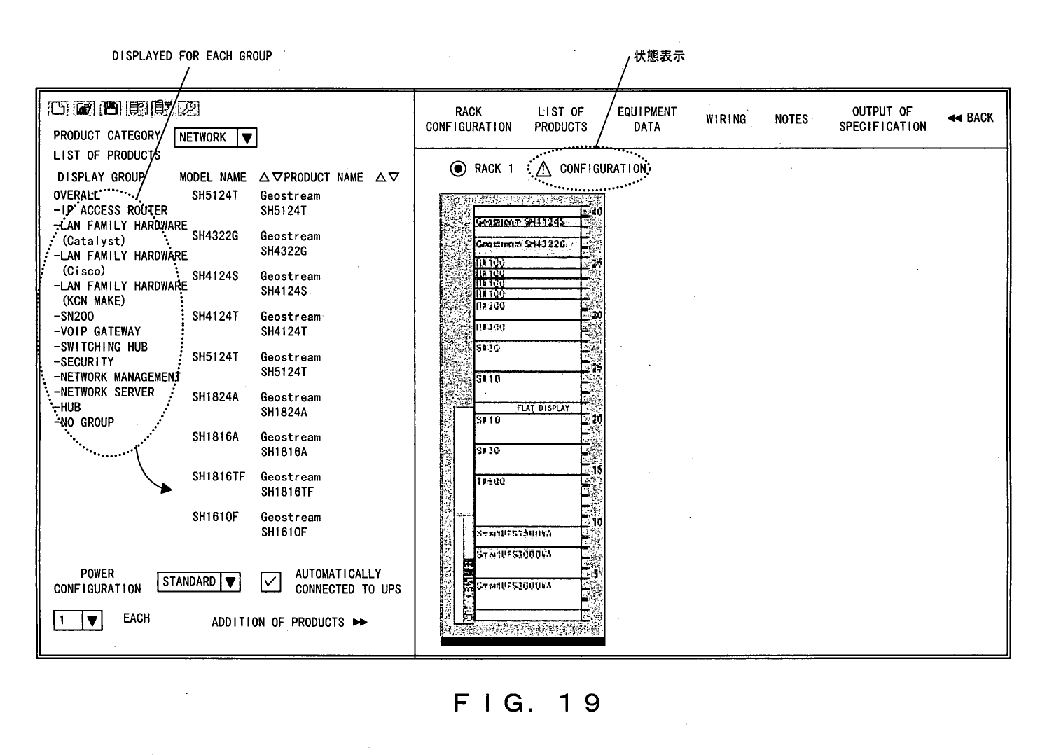

Array patterns optimally built thus are displayed in custom mode, as shown in FIGS. 18 and 19. In FIG. 18, not only the array of components but also their wiring states is displayed. At this moment, a component can be added, moved and deleted while viewing the screen. When performing these operations, the process in step 200 is performed. Therefore, the optimal state can be maintained. If the array is modified while displayed as shown in FIGS. 18 and 19 (that is, in custom mode), it can be set for each component whether the rules of the rule definition DB 70 should be applied. Therefore, the array of a component, its application to which is excluded can be modified regardless of the rules.

By displaying icons for both check according to the rules and no check on the top of rack state display, while displayed as shown in FIGS. 18 and 19, and also displaying the result of designated check contents, the arrayed state of components can be known in more detail.

A specific position or range can be designated as a mount-prohibited area. Since a component is not mounted in a rack position designated so, a specific rack position can be saved for future use.

Furthermore, the custom mode can be used when reading a complete or incomplete rack mount system stored in the rack configuration data DB 90 and modifying it. In this case, an existing attribute can be set in the read rack configuration data. If the existing attribute is set in the read rack configuration data, after that, the modified contents of the rack configuration data can be output anytime. Therefore, it is convenient, for example, when components are added after the setting of the existing attribute and only the added components are ordered.

The rack configuration determination support system of the present invention comprises a component save area in which an arbitrary component added to a rack can be temporarily deleted from the rack and stored while editing a rack configuration. A component stored in the component save area can be returned to the rack anytime. If there is such a component save area, it is convenient when an existing rack configuration is compared with a variety of other configurations.

<Update of Component DB 30 and Rule Definition DB 70>

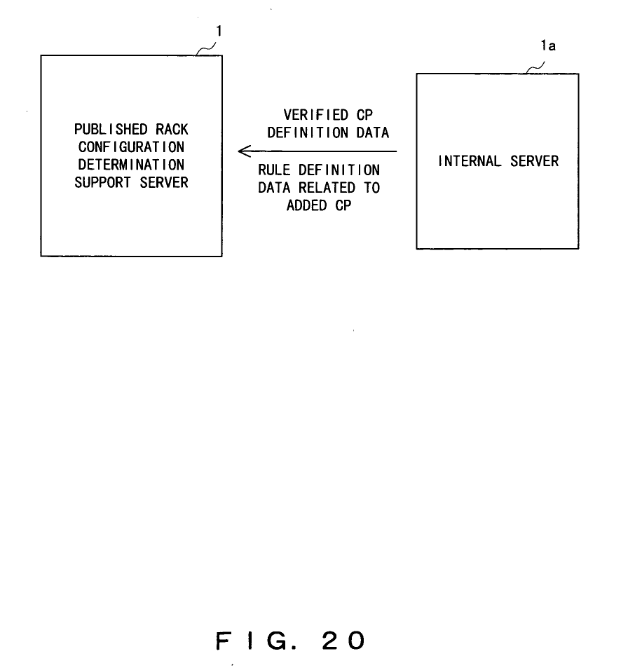

FIG. 20 is a basic block diagram showing how to update the component DB 30 and rule definition DB 70 according to another preferred embodiment of the present invention. In FIG. 20, reference numeral 1 represents the rack configuration determination support server of the present invention already described in detail, and actually provides a client with services. However, reference numeral 1a represents a server which although it has almost the same function as the server 1, is not published and updates the respective date of the component DB 30 and rule definition DB 70 of the server 1. Specifically, if a new component appears, it generates its CP definition data. In this case, if the data is loaded onto the server 1, confusion is caused if there is an error in the CP definition data. Therefore, before loading the CP definition data of a new component, it is preferable to verify its correctness sufficiently. Some components affect the rule definition data. When loading the CP definition data of such a component onto the server 1, related rule definition data must be modified or a new rule definition data must be added. Therefore, it is preferable to load CP definition data to be updated and rule definition data onto the server 1 after sufficiently verifying their correctness in server 1a.

According to the present invention, a rack system taking into consideration checkpoints for building a rack configuration can be built with neither the knowledge of a rack system configuration nor the collection of the specification information of a variety of components. A rack configuration determination support system for enabling not only for a general consumer to be able to easily use, but also for the manufacturer/seller of computers to be able to use for business, can be realized.

A rack system taking into consideration check points matching each product series (type) can also be built.

All the above-described preferred embodiments have been described just as examples. Therefore, a variety of alterations, modifications and additions of the above-described preferred embodiments along the technical idea or principle of the present invention could be easily anticipated by a person having ordinary skill in the art.

For example, although in the above-described preferred embodiments, a client accesses the rack configuration determination support server 1 through a network, the application of the present invention is not limited to such a network system, and it can also be applied to a stand-alone system.

[Appendix]

An example of the contents of the rule definition file of a PRIMERGY system

<Rule definition>

<rule proc=“addition” kind=“202”/> ----R1
<rule proc=“addition” kind=“301”/> ----R2
<rule proc=“Quantity restriction” kind=“101”/>

<target product num=“1”>group-PGMonitor</target

product>

</rule>
<rule proc=“quantity restriction” kind=”101>
<target product num=“1”>sysgrp-InnerDspSw</target

product>

</rule>
<rule proc=“quantity restriction” kind=“101”> ---R5

<target product num=“3”>sysgrp-3000UPS</target

product>

</rule>
<rule proc=“quantity restriction” kind=“101”> ---R9

| | |
|---|---|
| <target | product |

num=“5”>sysgrp-1400/1500UPS</target product>

</rule>
<rule proc=“quantity restriction” kind=“301”> ---R6

<target product num=“3”>sysgrp-3000UPS</target

product>

| | | |
|---|---|---|
| <target | product | num=“0” |

mark=“A”>sysgrp-1400/1500UPS</target product>

</rule>
<rule proc=“quantity restriction” kind =“301”> ---R7

<target product num=“2”>sysgrp-3000UPS</target

product>

| | | |
|---|---|---|
| <target | product | num=“0-1” |

mark=“A”>sysgrp-1400/1500UPS</ target product>

</rule>
<rule proc=“quantity restriction” kind=“301”> ---R8

<target product num=“1”>sysgrp-3000UPS</target

product>

| | | |
|---|---|---|
| <target | product | num=“0-5” |

mark=“A”>sysgrp-1400/1500UPS</target product>

</rule>
<rule proc=“quantity restriction” kind=“101”> ---R13

<target product num=“1”>group-PGMonitor</target

product>

</rule>
<rule proc=“array” kind=“101”> ---R3

<target product>serverN</target product>
<target product>serverN</target product>
<target product>serverN</target product>
<target product>serverN</target product>
<target product>serverN</target product>
<target product>sysgrp-serverX</target product>
<target product>serverN</target product>
<target product>sysgrp-serverX</target product>
<target product>serverN</target product>
<target product>group-server1</target product>
<target product>group-serverX</target product>
<target product>group-serverX</target product>
<target product>group-server3</target product>
<target product>group-serverX</target product>
<target product>group-serverX</target product>
<target product>group-serverX</target product>
<target product>group-serverX</target product>
<target product>group-serverX</target product>
<target product>group-serverX</target product>
<target product>group-server6</target product>
<target product>group-serverX</target product>
<target product>group-serverX</target product>
<target product>group-serverX</target product>
<target product>group-serverX</target product>
<target product mark=“A”>sysgrp-aaa</target

product>

<target product mark=“A”>cabi001</target

product>

<target product mark=“A”>sysgrp-bbbb</target

product>

| | | |
|---|---|---|
| <target | product | mark=“A”>ccccccc</target |

product>

<target product mark=“A”>sysgrp-Monitor</target

product> This includes a flat display.

</rule>
<rule proc=“array designation” kind=“101”> ---R10

<target product pos=“u24”>sysgrp-UPS</target

product>

</rule>
<rule proc=“array designation” kind=“101”> ---R11

| <applied rack>1002</applied rack> | | |
|---|---|---|
| <target | product | num=“0” |

pos=“24”>sysgrp-8chSwitch</target product>

| | | |
|---|---|---|
| <target | product | num=“1” |

pos=“24”>sysgrp-PGFlatDisplay</target product>

| | | |
|---|---|---|
| <target | product | num=“0”>cabi001</target |

product>

</rule>
<rule proc=“array designation” kind=“101”> ---R12

| <applied rack>1002</applied rack> | | |
|---|---|---|
| <target | product | num=“1” |

pos=“24”>cabi001</target product>

| | | |
|---|---|---|
| <target | product | num=“0”>cabi001</target |

product> (*cabi001 is the model name of a cabinet)

</rule>

<rule proc=“array designation” kind=“301”> ---R4

<applied rack>group-serverY</applied rack>
<target product>group-serverY</target product>
<target product>group-server3</target product>
<target product>group-serverY</target product>
<target product>group-serverY</target product>
<target product>group-server6</target product>
<target product>group-serverY</target product>
<target product>group-aaa</target product>
<target product>group-bbb</target product>
<target product>group-bbb</target product>
<target product>group-ccc</target product>
<target product>group-ddd</target product>
<target product>group-eee</target product>
<target product>group-eee</target product>
<target product>group-ggg</target product>
<target product>group-hhh</target product>
<target product>group-iii0</target product>
<target product>group-jjj</target product>
<target product>group-kkk</target product>
<target product>group-lll</target product>
<target product>group-mmm</target product>
<target product>group-nnn</target product>
<target product>group-ooo</target product>

</rule>
</rule definition>

1. A rack configuration determination support device for optimally arraying all components to be mounted, including necessary supplementary components when mounting components selected by a user on a rack to build a target system, comprising:
a component database composed of a plurality of segments of component definition data describing information about components that can be mounted on the rack;
a rule database composed of a plurality of segments of rule definition data describing a variety of rules led from a plurality of prescribed viewpoints when arraying the selected components on the rack;
an input unit enabling the user to input desired conditions for a target system, including selection of components; and
an array unit disposing each of the selected components in its selected order according to the variety of rules.

2. The rack configuration determination support device according to claim 1, wherein
said component database comprises sufficient information needed to optimally perform the array, and said rule database comprises sufficient constraints and rules needed to optimally perform the array.

3. The rack configuration determination support device according to claim 2, wherein
said plurality of prescribed viewpoints comprises addition, quantity restriction and array of components, and array designation of special components.

4. The rack configuration determination support device according to claim 2, wherein
said rule database comprises a rule definition file corresponding to each of types of the target system.

5. The rack configuration determination support device according to claim 2, wherein
said component definition data can include descriptions of components essential to each component.

6. The rack configuration determination support device according to claim 2, wherein
said input unit can set connection/non-connection of a UPS (uninterrupted power supply) in each of the components.

7. The rack configuration determination support device according to claim 6, wherein
said array unit comprises a unit selecting and adding an appropriate UPS when a component in which the connection of a UPS is set is included.

8. The rack configuration determination support device according to claim 6, further comprising
a unit adding a new UPS when capacity of said UPS is insufficient.

9. The rack configuration determination support device according to claim 6, wherein
said array unit comprises a unit adding a new rack when the rack cannot accommodate all the selected components on the rack.

10. The rack configuration determination support device according to claim 1, wherein
said component database and said rule database are described in a general markup language.

11. The rack configuration determination support device according to claim 1, wherein
said component definition data comprises a description defining a set product composed of a plurality of component.

12. The rack configuration determination support device according to claim 1, wherein
said array unit handles definition data defining a group composed of a plurality of components in the same manner as the component definition data.

13. The rack configuration determination support device according to claim 2, wherein
said input unit comprises a unit enabling a user to designate a position or a range as a component-mount prohibited area, and
said array unit arrays no component in the position or range.

14. The rack configuration determination support device according to claim 2, wherein
said component definition data of a first component comprises a description of a shape of a plug for the component,
said component definition data of a second component includes a description of a shape of a socket of the component, and
said array unit comprises a unit comparing the shape of the plug with the shape of the socket when the first and second components are interconnected, and if the shape of the plug and the shape of the socket are not matched, replacing the first component with a matching component.

15. The rack configuration determination support device according to claim 2, wherein
said array unit comprises an addition unit measuring a distance between both the components when interconnecting the first and second components, and adding a cable with an appropriate length if determining that a cable attached as a standard accessory is too short.

16. The rack configuration determination support device according to claim 2, wherein
said addition unit takes into consideration not only the distance but also redundancy in length so that the first or second component can be pulled out of the rack at the time of maintenance.

17. The rack configuration determination support device according to claim 2, further comprising
a unit displaying the array of components to be mounted on the rack, including a wiring state between the components.

18. The rack configuration determination support device according to claim 2, further comprising
a third database enabling a user to register component definition data of a component whose definition said component database does not include, wherein
said array unit handles the third database in the same manner as said component database.

19. A rack configuration determination support method for optimally arraying all components to be mounted, including necessary supplementary components when mounting components selected by a user on a rack to build a target system, comprising:
preparing a component database composed of a plurality of segments of component definition data describing information about components that can be mounted on the rack;
preparing a rule database composed of a plurality of segments of rule definition data describing a variety of rules led from a plurality of prescribed viewpoints when disposing the selected components on the rack;
enabling the user to input desired conditions for the target system, including the selection of components; and
arraying each of the selected components in its selected order according to the variety of rules.

20. A computer-readable storage medium on which is recorded a data structure for enabling a computer to optimally array all components to be mounted, including supplementary components when mounting components selected by a user on a rack to build a target system, said data structure comprising:
a component database composed of a plurality of segments of component definition data describing information about components that can be mounted on the rack;
a rule database composed of a plurality of segments of rule definition data describing a variety of rules led from a plurality of prescribed viewpoints when arraying the selected components on the rack;
an instruction sequence enabling the computer to enable the user to input desired conditions of the target system, including selection of the component; and
an instruction sequence enabling the computer to array each of the selected components according to the variety of rules in its selected order.

21. The computer-readable storage medium according to claim 20, wherein
said component database comprises sufficient information needed to optimally perform the array and
said rule database comprises sufficient constraints and rules needed to optimally perform the array.

22. The computer-readable storage medium according to claim 21, wherein
said plurality of prescribed viewpoints include addition, quantity restriction and array of components, and array designation of special components.

23. The computer-readable storage medium according to claim 21, wherein
said rule database comprises a rule definition file corresponding to each of types of the target system.

24. The computer-readable storage medium according to claim 21, wherein
said component definition data can include descriptions of components essential to each component.

25. The computer-readable storage medium according to claim 21, wherein
said input unit can set connection/non-connection of a UPS (uninterrupted power supply) in each of the components.

26. The computer-readable storage medium according to claim 25, wherein
said array unit comprises a unit selecting and adding an appropriate UPS when a component in which the connection of a UPS is set is included.

27. The computer-readable storage medium according to claim 25, wherein
said data structure further comprises an instruction sequence enabling the computer to add a new UPS when capacity of said UPS is insufficient.

28. The computer-readable storage medium according to claim 25, wherein
said array function comprises a unit adding a new rack when the rack cannot accommodate all the selected components on the rack.

29. The computer-readable storage medium according to claim 20, wherein
said component database and said rule database are described in a general markup language.

30. The computer-readable storage medium according to claim 20, wherein
said component definition data includes a description defining a set product composed of a plurality of components.

31. The computer-readable storage medium according to claim 20, wherein
said array unit handles definition data defining a group composed of a plurality of components in the same manner as the component definition data.

32. The computer-readable storage medium according to claim 21, further comprising
said input function includes a function enabling a user to designate a position or a range as a component-mount prohibited area, and
said array function arrays no component in the position or range.

33. The computer-readable storage medium according to claim 21, wherein
said component definition data of a first component includes a description of a shape of a plug for the component,
said component definition data of a second component includes a description of a shape of a socket of the component, and
said array function includes a function to compare the shape of the plug with the shape of the socket when the first and second components are interconnected, and if the shape of the plug and the shape of the socket are not matched, to replace the first component with a matching component.

34. The computer-readable storage medium according to claim 21, wherein
said array function includes an addition function to measure a distance between both the components when interconnecting the first and second components, and to add a cable with an appropriate length if determining that a cable attached as a standard accessory is too short.

35. The computer-readable storage medium according to claim 21, wherein
said addition function takes into consideration not only the distance but also redundancy in length so that the first or second component can be pulled out of the rack at the time of maintenance.

36. The computer-readable storage medium according to claim 21, wherein
said data structure further comprises an instruction sequence enabling the computer to display the array of components to be mounted on the rack, including a wiring state between the components.

37. The computer-readable storage medium according to claim 21, further comprising
a third database enabling a user to register component definition data of a component whose definition is not included in said component database, wherein
said array function handles the third database in the same manner as said component database.

38. A program for enabling the computer comprising a component database composed of component definition data describing information about components that can be mounted on the rack and a rule database composed of rule definition data describing a variety of rules led from a plurality of prescribed viewpoints when arraying the selected components on the rack, in order to optimally array all components to be mounted, including supplementary components when mounting components selected by a user to build a target system to perform a function, said function comprising:
enabling the user to input desired conditions of the target system, including selection of the components; and
arraying each of the selected components according to the variety of rules in its selected order.
